(19) United States
(12) Patent Application Publication
(10) Pub. No.: US 2012/0269379 A1
(43) Pub. Date: Oct. 25, 2012

(54) DIAPHRAGM USED IN A LOUDSPEAKER AND A LOUDSPEAKER

(75) Inventors: Peng GAO, Suzhou City (CN); Guoqiang Chai, Suzhou City (CN); Jianming Zhou, Suzhou City (CN)

(73) Assignee: SUZHOU SONAVOX ELECTRONICS CO., LTD., Suzhou City (CN)

(21) Appl. No.: 13/431,223

(22) Filed: Mar. 27, 2012

(30) Foreign Application Priority Data
Mar. 28, 2011 (CN) 201110075303.6

(51) Int. Cl. H04R 1/00; H04R 7/04

(52) U.S. Cl. 381/398; 181/157

(57) ABSTRACT

A diaphragm and a loudspeaker using the diaphragm are disclosed. The diaphragm has a diaphragm body with at least one projection formed thereon, to reduce peaks in the medium-high frequency section of the frequency response curve for the loudspeaker, and make the frequency response curve smooth in medium-high frequency. Thereby the sound effect of medium-high frequency section is improved, and the original sound can be reflected more veritably

This application claims priority to CN Application No. 201110075303.6, filed Mar. 28, 2011, the entire contents of which is hereby incorporated herein by reference.

### FIELD OF THE INVENTION

The present invention relates to a loudspeaker, and more particularly to a diaphragm in the loudspeaker.

DESCRIPTION OF THE RELATED ART

Loudspeaker is an electro-acoustic transducer device, the diaphragm of which vibrates due to the electromagnetic effect produced from electric energy, and the vibrating diaphragm resonates with the ambient air to produce sound. The shape of the diaphragm always influences the sound effect. The diaphragm of existing loudspeakers generally has a truncated cone shape. When the conical inclined wall of the diaphragm sounds by vibration, peaks often arise in the medium-high frequency of the frequency response curve, such as the frequency section of 2000 Hz-3000 Hz, which may create harsh or hoarse sound, therefore resulting in distortion of original sound and poor sound effect.

### SUMMARY OF THE INVENTION

The object of the present invention is to provide a loudspeaker diaphragm which can reduce peaks in the medium-high frequency, and a loudspeaker provided with a smooth medium-high frequency of frequency response curve. For the above purpose, one aspect of the invention is to provide a diaphragm for a loudspeaker. The diaphragm comprises two ends, and a diaphragm body located between the two ends which has a front side and back side, wherein the inside diameter of one end of the deaphragm is greater than the other end, and the cross section of the diaphragm body is ring-shaped. The diaphragm body includes a main body having a truncated cone shape, and further comprises at least one projection protruding on the front side of the diaphragm body from the main body thereof. The projection formed on the diaphragm body of the diaphragm can reduce peaks in the medium-high frequency of the frequency response curve, thereby making the medium-high frequency of the frequency response curve smoother.

Preferably, there are a plurality of projections distributed at intervals along the periphery of the diaphragm body.

More preferably, the projections are formed in pairs. Each pair of projections are symmetrically distributed about the central axis of the diaphragm body.

Still more preferably, through-holes are opened on at least one pair of projections respectively, which are covered with waterproof sheets. The through-holes opened on the pair of projections are symmetrically distributed about the central axis of the diaphragm body.

Preferably, each projection extends along the periphery of the diaphragm body forming a ring shape.

Preferably, a through-hole is opened on at least one projection, and the through-hole is covered with a waterproof sheet. The through-holes formed on the projections of the diaphragm can further reduce peaks or troughs in the medium-low frequency of the frequency response curve of a loudspeaker utilizing the diaphragm, and make both the medium-high and medium-low frequency sections of the frequency response curve smoother, and thus the sound effect of the loudspeaker is further improved, thereby making the sound more real and nice.

Another aspect of the invention is to provide a loudspeaker comprising the foregoing diaphragm.

In a preferred embodiment, the loudspeaker also includes a frame, a fixing magnetic circuit assembly fixed on the frame, and a voice coil which is able to be driven by the fixing magnetic circuit assembly to move axially. The central portion of the frame is recessed and thus a resonant cavity is formed inside the frame, and the diaphragm is located within the resonant cavity. The outer wall of the voice coil is coupled to the inner wall of the frame via a positioning elastic sheet. The inner wall of the end of the diaphragm having smaller inside diameter is bound to the outer wall of the voice coil, and the other end of the diaphragm having bigger inside diameter is bound to the inner wall of the frame via an elastic edge.

Due to the above technical solution, the present invention has the following advantage over the prior art that the invention improves the sound effect of the medium-high frequency section, and can reproduce the original sound more really.

### BRIEF DESCRIPTION OF DRAWINGS

FIG. 1 is a front view of a diaphragm according to a preferred embodiment of the invention, wherein an elastic edge is bound to the outer end of the diaphragm;

FIG. 2 is a sectional view along A-A section shown in FIG. 1;

FIG. 3 is an enlarged view of the B section shown in FIG. 2;

FIG. 4 is a front view of the loudspeaker according to the invention; and

FIG. 5 is a sectional view along A-A section shown in FIG. 4.

### DETAILED DESCRIPTION OF THE INVENTION

Preferred embodiments of the present invention will be described hereinafter with reference to the drawings. It is to be noted, however, that the appended drawings illustrate only typical embodiments of this invention, they are not to be considered limiting of its scope, for the invention may admit to other equally effective embodiments.

As shown in FIGS. 1 to 3, the diaphragm 1 used for loudspeaker comprises two ends, and a diaphragm body 2 located between the two ends. Substantially the diaphragm 1 has a truncated cone shape, and the inside diameter of one end of the diaphragm is greater than the other end thereof.

The cross section of the diaphragm body 2 has a closed ring shape, and the main body of the diaphragm body 2 has a truncated cone shape. The diaphragm body 2 has at least one projection 3 protruding on the front side from the main body of the diaphragm body 2. Generally, the diaphragm body 2 is monolithic, i.e. the main body and the projection are formed integrally. The phrases of “front side” and “back side” mentioned herein and throughout the specification are defined according to the observation habit, as the side can be seen is denominated as “front side” when the diaphragm is mounted to the loudspeaker, while the opposite side is referred to as “back side”. The phrases of “inside” and “outside” mentioned hereinafter are defined according to the distance to the central axis of the diaphragm body 2. Actually, the front side of the diaphragm body 2 is inside, and the back side of the diaphragm body 2 is outside.

The projection 3 can be configured in various ways.

For example, the projection extends along the periphery of the diaphragm body forming a ring shape, i.e., this creates a continuous conformation of the projection (not shown in appended figures).

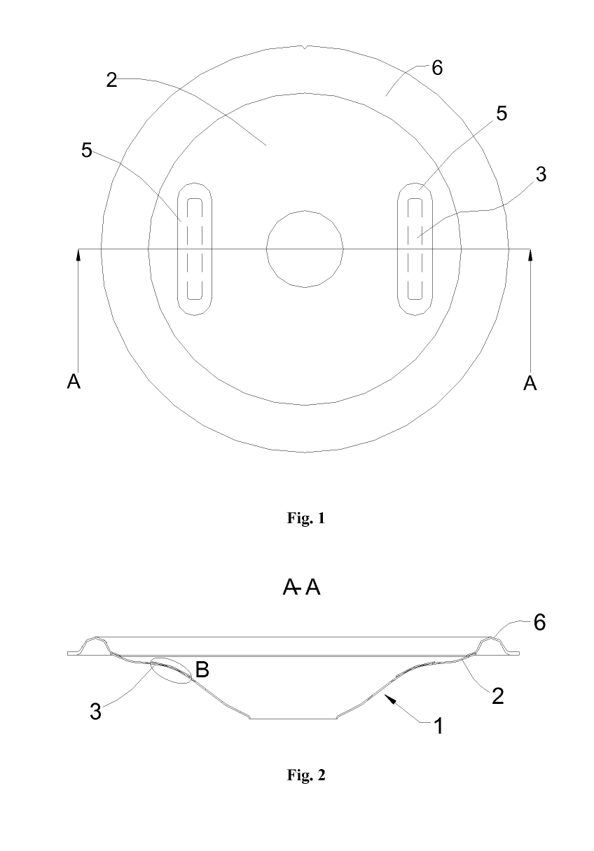

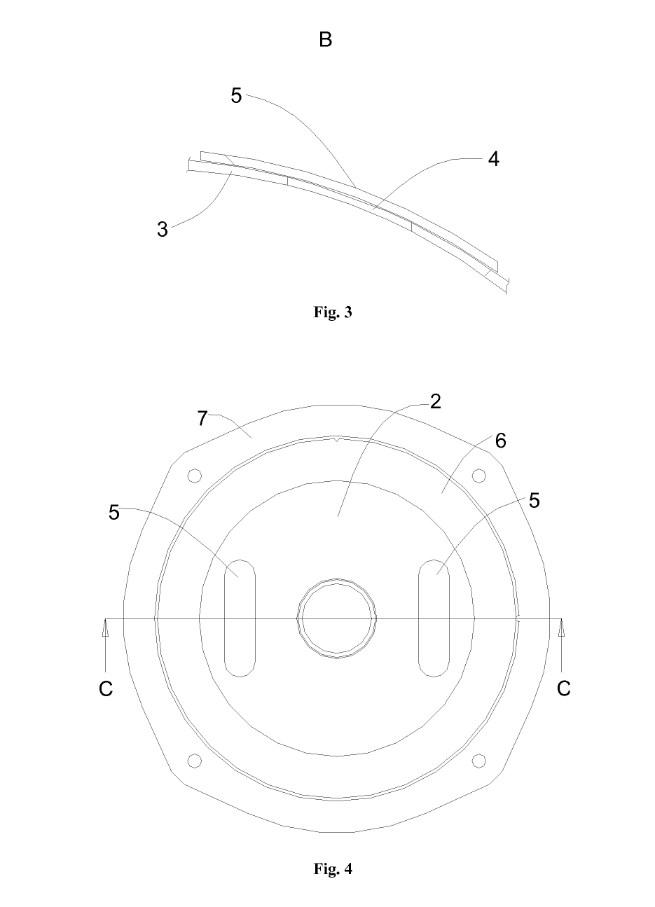

Alternatively, there are a plurality of projections 3 distributed interruptedly, e.g., the plurality of projections 3 are distributed at intervals along the periphery of the diaphragm body 2. Preferably the projections 3 are formed in pairs. In a preferred embodiment of the present invention, there is one pair of projections 3, as shown in FIGS. 2-3 and 5, and the pair of projections 3 are symmetrically distributed about the central axis of the diaphragm body 2. As shown in FIG. 3, on the longitudinal section of the diaphragm 1, i.e., on the section formed from axially cutting of the diaphragm body 2, the projections 3 are arc shaped, and the height of the projections 3 gradually reduces along the direction from outside to inside. In other additional embodiments, the projections 3 can be formed as such as right-angle shape (not shown in appended figures).

Through-holes 4 are opened on the projections 3, and the through-holes 4 are covered with waterproof sheets 5, as shown in FIGS. 2-3 and 5, so that the better sound effect can be achieved for the loudspeaker.

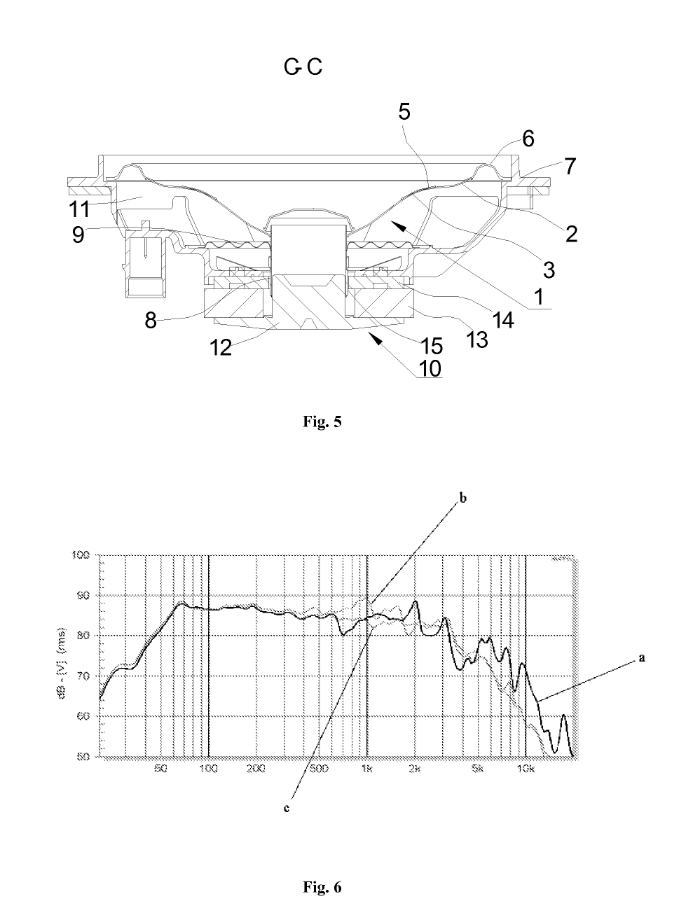

The use of the diaphragm in loudspeakers will be further illustrated hereinafter with reference to the FIGS. 4 to 5, by taking the diaphragm provided with pairs of projections as example.

As shown in FIG. 4, the loudspeaker comprises a frame 7, on which the diaphragm is mounted. The diaphragm body 2 of the diaphragm and an elastic edge 6 used for coupling the diaphragm with the frame 7 can be seen from the figures. As shown in FIG. 5, the central portion of the frame 7 is recessed and a resonant cavity 11 is formed therefore. The diaphragm 1 is situated within the resonant cavity 11. On the frame 7 are disposed a fixing magnetic circuit assembly 10 and a voice coil 8 can be driven by the fixing magnetic circuit assembly 10 to move axially . The outer wall of the voice coil is coupled to the inner wall of the frame 7 via a positioning elastic sheet 9. Wherein the end of the diaphragm 1 having smaller inside diameter is bound to the outer wall of the voice coil 8, and the other end of the diaphragm having bigger inside diameter is bound to the inner wall of the frame 7 via the elastic edge 6.

As shown in FIG. 5, the fixing magnetic circuit assembly 10 comprises an annular iron sheet 14, an annular magnetic steel 13 and a T-shape iron 12 sequentially connected to each other. Wherein the iron sheet 14 is riveted on the frame 7, and the T shape iron 12 has a center column being inserted into the inner cavities of the iron sheet 14 and the magnetic steel 13. The annular iron sheet 14, the annular iron magnetic steel 13 and the T-shape iron 12 form a magnetic loop, and an annular magnetic gap 15 is formed between the center column of the T-shape iron 12 and the iron sheet 14 and magnetic steel 13. The voice coil 8 is inserted into the magnetic gap 15. Therefore, a magnetic field varying with audio current will be generated when audio current flows through the voice coil 8, and the magnetic field would interact with the magnetic field generated from the magnetic loop in the fixing magnetic circuit assembly 10, thereby making the voice coil 8 vibrate axially and further promote the diaphragm 1 to sound with vibration.

Frequency response curves of three loudspeaker is illustrated in FIG. 6.

In FIG. 6, curve “a” represents the frequency response curve of the loudspeaker utilizing a conventional diaphragm, namely a diaphragm having a truncated cone shape described in the prior art. By comparing curve b with curve a, it can be seen that the loudspeaker provided with the diaphragm having projections in pairs can reduce peaks in medium-high frequency section, such as 2000 Hz˜3000 Hz, and the medium-high frequency of the frequency response curve for such loudspeaker is smoother, thus, the sound effect of medium-high frequency is improved and the original sound can be reflected more veritably. Generally the frequency range audible is 20 Hz˜20 KHz, which is divided into three frequency sections of low, medium and high, wherein the low frequency section refers to 20 Hz˜640 Hz, the medium frequency section refers to 640 Hz˜2500 Hz, and the high frequency medium refers to 2500 Hz˜20 KHz.

It can be seen from curve “b” shown in FIG. 6 that, although the projections 3 formed on the loudspeaker diaphragm 1 can reduce peaks in medium-high frequency, but peaks or troughs may be created in the medium-low frequency section, such as 600 Hz˜1500 Hz. In order to reduce peaks or troughs in medium-low frequency section, through-holes 4 should be opened on at least one pair of projections 3, and the through-holes 4 are covered with waterproof sheets 5, as shown in FIGS. 1 and 5. The waterproof sheet 5 can be a rubber sheet, and the through-holes 4 on projections 3 in pairs should be symmetrically distributed about the central axis of the diaphragm body 2. Curve “c” in FIG. 6 shows the frequency response curve for the loudspeaker utilizing the diaphragm 1 which has projections 3 with through-holes 4 opened thereon, by which it is easy to realize, that the frequency response curve for this loudspeaker is smooth in the medium-high and medium-low frequency sections thereof, and thus the sound effect of the loudspeaker is further improved, thereby making the sound more real and nice.

In conclusion, the projections disposed on the diaphragm body of the loudspeaker diaphragm can suppress the sub-vibration effectively, and reduce peaks in the medium-high frequency section of the frequency response curve for the loudspeaker, while the through-holes opened on the projections with the waterproof sheets covering the through-holes can make the frequency response curve smoother in medium-low frequency section thereof.

What is claimed is:

1. A diaphragm used in a loudspeaker, comprising
two ends, wherein the inside diameter of one end being greater than the other end; and
a diaphragm body located between the two ends having a front side and back side, the cross section of which is ring-shaped, said diaphragm body including a main body in a truncated cone shape;
is characterized in that, at least one projection protruding on the front side of the diaphragm body from the main body thereof.

2. The diaphragm as claimed in claim 1, wherein a plurality of projections are formed by protruding from the main body, the plurality of projections being distributed at intervals along the periphery of the diaphragm body.

3. The diaphragm as claimed in claim 2, wherein the plurality of projections are formed in pairs, each pairs of projections being symmetrically distributed about the central axis of the diaphragm body.

4. The diaphragm as claimed in claim 3, wherein through-holes are opened respectively on at least one pair of projections, each through-hole being covered with a waterproof sheet, wherein the through-holes on each pair of projections being symmetrically distributed about the central axis of the diaphragm body.

5. The diaphragm as claimed in claim 1, wherein the projection extends along the periphery of the diaphragm body forming a ring shape.

6. The diaphragm as claimed in claim 1, wherein a through-hole is opened on at least one projection, said through hole being covered with a waterproof sheet.

7. A loudspeaker comprises the diaphragm as claimed in claim 1.

8. The loudspeaker as claimed in claim 7, wherein the loudspeaker further comprises
a frame, the central portion of the frame being recessed to form a resonant cavity inside within which the diaphragm is located;
a fixing magnetic circuit assembly, being fixed on the frame, and
a voice coil, which is driven to move axially by the fixing magnetic circuit assembly, wherein the outer wall of the voice coil being coupled to the inner wall of the frame via a positioning elastic sheet, and the inner wall of the end of the diaphragm having smaller inside diameter being bound to the outer wall of the voice coil, and the other end of the diaphragm having bigger inside diameter being bound to the inner wall of the frame via an elastic edge.
